(19) United States
(12) Patent Application Publication
(10) Pub. No.: US 2004/0039798 A1
(43) Pub. Date: Feb. 26, 2004

(54) Domain name resolution system and method

(75) Inventors: Steven M. Hotz, Plya Del Ray, CA (US); Rodney L. Joffe, Phoenix, AZ (US); William C. Manning, El Segundo, CA (US); Alec H. Peterson, Lakewood, CO (US); Michael A. Hotz, Phoenix, AZ (US); Ronald D. Lachman, Northbrook, IL (US)

Correspondence Address: PILLSBURY WINTHROP, LLP, P.O. BOX 10500, MCLEAN, VA, 22102, US

(73) Assignee: Ultradns, Inc.

(21) Appl. No.: 10/463,663

(22) Filed: Jun. 18, 2003

Related U.S. Application Data
(62) Division of application No. 09/516,181, filed on Mar. 1, 2000.
(60) Provisional application No. 60/124,022, filed on Mar. 3, 1999.

(51) Int. Cl. G06F 15/16

(52) U.S. Cl. 709/219; 709/241; 709/244

(57) ABSTRACT

A domain name server (DNS) system for processing domain name requests includes a query mechanism constructed and adapted to obtain a user request for response information corresponding to a particular domain name; and provide complete response information in a single response to the user request. The user request may be a domain name resolution request and the query mechanism provides an Internet Protocol (IP) address corresponding to the domain name. A different response may be provided, depending on context information. The system may include an Internet protocol processor and an underlying database repository. The system incorporates a database layout and associated database query strategy that may comprise multiple components which significantly reduces the transaction processing time and overhead as compared to conventional implementations.

### RELATED APPLICATIONS

This patent application is a division under 35 USC §120 of U.S. patent application Ser. No. 09/516,181 entitled “SCALABLE AND EFFICIENT DOMAIN NAME RESOLUTION,” filed Mar. 1, 2000, co-pending, and is related to and claims priority under 35 USC §119(e) to U.S. Provisional Patent Application No. 60/124,022, titled “DOMAIN NAME RESOLUTION,” filed Mar. 3, 1999, which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

This invention relates generally to enhanced domain name servers, and more particularly, to efficiently processing domain name queries in a network such as the Internet.

2. Background

The Internet has brought about an information revolution through the development of computerized information resources, on-line services and the World Wide Web (WWW). The Internet is growing rapidly, with an ever increasing number of computers and users being connected to the Internet daily.

In order for devices (computers, printers, and the like) on a network such as the Internet to be able to communicate with each other, the devices need to know (or be able to determine) each others' addresses. Many distributive systems (e.g., the Internet) assign device names in the distributive system by a hierarchical naming scheme known as domain names. An Internet domain name is generally a sequence of domain labels separated by periods. For example, “a.ultradns.com” is a domain name where “com” is a top level domain name of a top level domain, “ultradns” is a second level domain name of a second level domain and “a” is a third level domain name of a third level domain. A device in a domain is labeled by the name of the device followed by the domain name. Thus, a device labeled “server” in the “a.ultradns.com” domain has the name, “server.a.ultradns.com”. A device name is also referred to as a domain name. The Domain Name System (DNS) is a distributed hierarchical database comprised of client/server transaction servers that provide a mapping from domain names to associated information, e.g., to IP addresses.

While domain names partition a distributive system in a logical and hierarchical manner, messages are transferred between devices of the DNS by identifying devices using specific IP addresses. In the present Internet protocol, IP addresses are thirty-two-bit numbers that are expressed as four eight-bit values (i.e., four numbers in the range 0 to 255) separated by periods, e.g., “121.121.122.2”. IP addresses contain information such as a network identifier (“ID”) of a device network connection and a device ID. IP address are assigned by an address authority. The addresses are assigned in blocks to authoritative address servers.

A comprehensive description of the operation of domain name servers and IP addresses is given in DNS and BIND In A Nutshell, Paul Albitz and Cricket Liu, O'Reilly & Associates, 1994, ISBN: 1-56582-010-4, which is incorporated herein by reference.

IP addresses also relate to each other in a hierarchical manner. Thus, the DNS also provides a “reverse mapping” of IP addresses to domain names, by using a representation of the IP address that follows the DNS indexing model. However, the domain name hierarchy and the IP address hierarchy are not directly related to each other. While some name servers are also address servers, name and address servers do not have to be the same device. Thus, it is possible for a server to have authority to resolve a domain name into a corresponding IP address of a device, the same name server may not be able to resolve the IP address to the corresponding domain name of the same device. Thus, resolution of IP addresses to domain names follows a similar process as resolving domain names to IP addresses except different servers may be involved.

Because IP addresses are numerical and, unlike domain names, are assigned without regard to the logical and hierarchical organization of the DNS, domain names are generally used in instructions for functions such as data transfers. Thus, a data transfer instruction identifies the receiving device by its domain name. However, the domain name must be translated into a corresponding IP address before the data transfer can occur.

Domain names are managed by authoritative devices called name servers. That is, domain name servers perform the task of converting names to IP addresses. Name servers translate domain names into corresponding IP addresses and vice versa. When a first device desires to transfer a message to a second device known only by its domain name, the first device must query a name server to acquire the corresponding IP address to the known domain name of the second device.

It is estimated that by the year 2003, the number of domains on the Internet will increase ten-fold, exceeding 150 million domains. Associated with this increase in the number of domains will be an increase in user dissonance. Current implementations of the Domain Name System are entirely inadequate and unable to handle resultant DNS files' size or the magnitude and frequency of changes to these DNS files. Even today, real problems exist with content access and/or content distribution over the Internet. It is estimated that ten to thirty percent of Internet connection events are unsuccessful or unsatisfactory.

### SUMMARY

The present invention provides a scalable and flexible platform for providing global directory services. In some embodiments, the invention uses redundant information servers to provide ubiquitous and high-performance access to directory services. This system of servers leverages the scalability and replication mechanisms provided by commercial database software. The DNS according to the present invention has an underlying modular design which allows additional wire-protocol services to be easily incorporated into the system, and allows additional modules to provide intelligent/dynamic responses by affecting changes in the data repository.

In various aspects, the present invention:

Supports large-scale service model better than alternative DNS servers.

Integrates other Internet services, e.g. “whois”, in a single data repository.

Multi-threaded server provides scalability to exploit commercial-level hardware.

Modular database implementation facilitates the addition of new features.

Database replication provides for ease of management of distributed servers, and database backup features provide information integrity.

Globally distributed server replicas provide the reliability, throughput and low delay required to scale a large commercial service. The servers are tied together using advanced Internet routing mechanisms that are reactive to the state of individual server replicas.

Multiple servers provide increased system throughput, reliability in the event of server failure, reliability in the event of provider network failure and nearest server mechanics serve as basis for advanced redirection service.

Embodiments of the present invention provide a DNS system based on an information-centric design, where multiple system components interact with system state that is maintained in the database. The database provides both the principle Internet information, and the required associations and configuration to specify the operation of the active components. The system allows for reduced operational staff requirements by supporting custom user-interface for direct management of user data, with integrated security and data validation to maintain data integrity.

The present invention also provides:

Information update via multiple user-specific custom interfaces, program APIs, or

Internet services such as dynamic DNS updates.

Fine-granularity security based on association between login and information objects.

Modular active components for reporting, billing and data integrity checking.

In one aspect, this invention provides a system for processing domain name requests. The system includes a query mechanism constructed and adapted to (a) obtain a user request for response information corresponding to a particular domain name; and (b) provide complete response information in a single response to the user request. The user request may be a domain name resolution request, in which case the query mechanism provides an Internet Protocol (IP) address corresponding to the domain name. The system accommodates user requests for other typed DNS data.

In some embodiments the a query mechanism is further constructed and adapted to provide the response depending on context information. The context information may include at least one of (a) context information from the request; (b) context information from the system; and (c) global context information.

The context information may include address information indicating an address of the user; the local time; and/or the location of the system.

In some embodiments, the system has a data cache and the query mechanism is further constructed and adapted to, upon receipt of a user request, first attempt to find an answer to the user request in the data cache.

In some embodiments, the query mechanism is further constructed and adapted to (a) if the answer exists in the data cache and the answer is fresh, send the answer directly from the cached data; and (b) if the answer exists in the data cache and the answer is stale, or if the answer does not exist in the data cache, then acquire the answer from a database; send the answer; and update the data cache to reflect the acquired answer.

Sometimes items in the data cache have a maximum lifetime which ranges from the time to live of the lowest resource record in a complete answer to the maximum cache time value configured for the system as a whole.

In some embodiments, the query mechanism is further constructed and adapted to implement negative caching such that if a request is made for a host that does not exist in an active domain, the negative response will be saved in the cache.

In another aspect, this invention is a method of providing an Internet Protocol (IP) address of one of a plurality of devices on the Internet. The method includes obtaining a user request for an IP address corresponding to a particular domain name; and providing the IP address in a single response to the user request. The method may include providing the IP address depending on context information. The context information may include at least one of (a) context information from the user request; (b) local context information; and (c) global context information.

In yet another aspect, this invention is a system comprising a network of distributed Domain Name Servers (DNSs), each DNS comprising a database; and a query mechanism constructed and adapted to obtain from the database a user request for response information corresponding to a particular domain name; and to provide complete response information in a single response to the user request. The databases in the network are replicated.

### BRIEF DESCRIPTION OF THE DRAWINGS

The objects and advantages of the invention will be apparent upon consideration of the following detailed description, taken in conjunction with the accompanying drawings, in which the reference characters refer to like parts throughout and in which:

FIG. 1 provides an overview of embodiments of the present invention operating within the Internet; and

FIG. 2 depicts the logical structure of the database schema according to embodiments of the present invention.

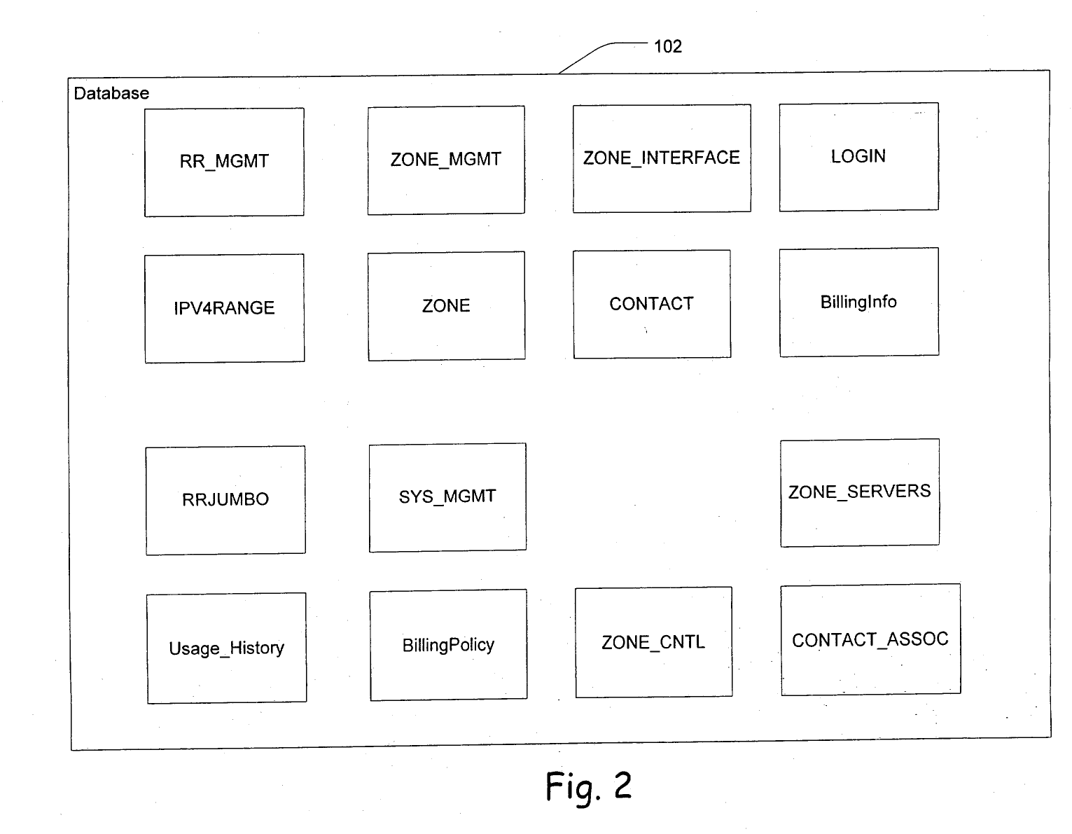

### DETAILED DESCRIPTION

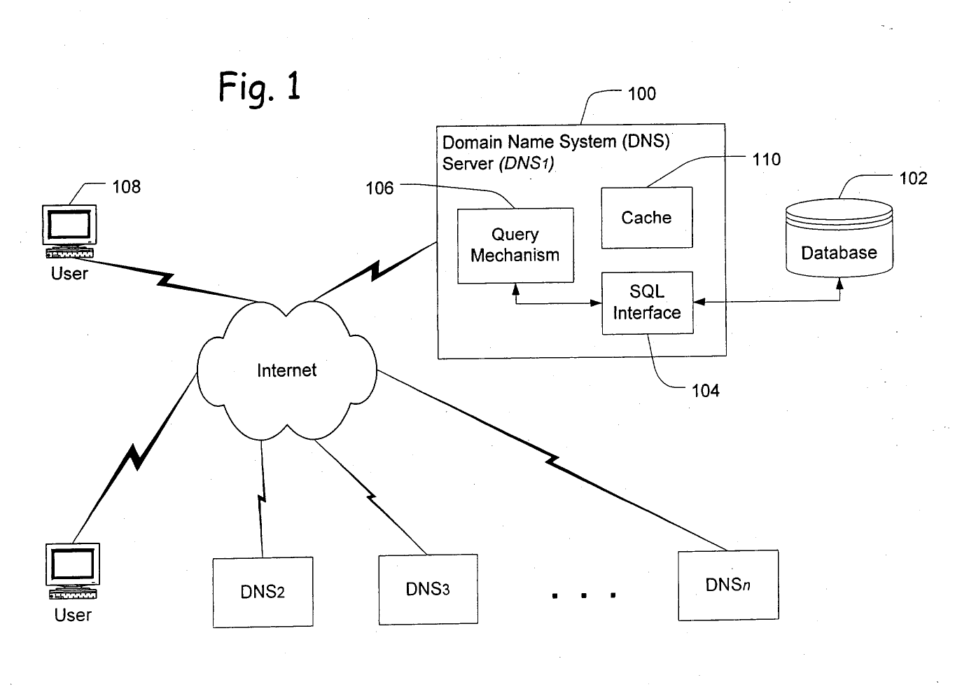

With reference to FIG. 1, a Domain Name System (DNS) server 100 (DNS₁) according to the present invention comprises a database 102 having a unique database schema and a complementary unique SQL interface 104. A query mechanism 106 uses the SQL interface 104 to query the database 102 and to return results to requesting users, e.g., user 108.

The present invention can be considered at two levels, namely at a server level (e.g., DNS₁ 100) and at a system level (e.g., DNS₁, DNS₂, . . . , DNSn).

Server-Level: At the server level, this invention provides mechanisms that enable a DNS server (e.g., DNS₁ 100) according to the present invention to achieve sufficient performance (circa thousands of queries/second) even though the underlying data repository supports basic data retrieval at a rate of hundreds of queries/second.//

Features of this server level, discussed below in detail, include:

Aggregate database queries

Common case optimizations

Data caching (and consequently-required cache invalidation mechanisms)

System-Level: At the system level, this invention provides mechanisms that enable a system of DNS servers (e.g., DNS₁, DNS₂, . . . , DNSn in FIG. 1) to provide enhanced/integrated management of information, and provides various levels of performance enhancement for incoming queries and internal transactions.

Features of this system level, discussed below in detail, include:

Modular data-centric design

Database-layer synchronization

Single IP address announcement of replicated servers

The server-level mechanisms according to the present invention enable the DNS server to achieve a greater transaction throughput rate. The system-level mechanisms work synergistically, and allow the DNS System according to the present invention to provide a diverse set of features and benefits.

The server-level mechanisms according to the present invention enable the modular data-centric design and database-layer synchronization.

Server-Level Mechanisms

A name server response to a DNS query requires a complex set of calculations that allow:

(a) different responses to be returned depending on the servers authority,

(b) different answers depending on the existing domain name data, and

(c) the server to return an answer comprised of multiple inter-dependent sections.

Specifically, a DNS's response algorithm must consider at least the following:

Three response sections: Answers, Authority, and Additional CNAME (domain name alias) dereferencing

Wild card matching (matching of leading superstrings)

Iterative domain name search (matching the longest recognized domain name)

Conventional (prior art) DNS servers make many distinct queries to the data repository in order to determine the correct records to include in a response. Consequently, the transaction rate of the DNS server will be reduced by a similar factor (e.g., if eight database queries are required, transaction rate will be reduced by approximately a factor of eight). The DNS server according to the present invention significantly reduce the average number of queries required to construct a DNS response, as compared with conventional so-called “straight forward” algorithms that depend on many distinct queries to the data repository.

Aggregate Database Queries

The DNS server according to the present invention uses compound database queries so that a single query can return multiple component records required to construct a DNS response. Moreover, database queries are correlated so that in instances where multiple queries are required, subsequent queries can be optimized based on records retrieved by earlier database queries. The DNS query strategy according to the present invention:

retrieves combinations of Answer, Authority, and Additional records in a single query,

retrieves available CNAME records along with Answer/Authority/Additional records, and

reduces iterative domain name search overhead by correlating records from different iterations.

With this invention, the number of database queries required to construct a complete DNS response can be as low as one. This is a considerably improvement when compared to a similar strategy based on simple database queries that would require a separate query for each of Answers and Authority, and multiple queries for Additional records.

Common Case Optimization

In general, common case optimizations are effective in systems where there are a number of distinct potential outcomes (a) with different probabilities of occurrence, (b) requiring varying levels of incremental overhead, and (c) where a determination can be made that a specific outcome has been reached, without an exhaustive outcome analysis.

The present invention recognizes that common case optimization is applicable to the DNS server database query strategy, and has identified two specific optimizations based on knowledge of DNS protocols and the expected incoming query stream. The DNS system according to the present invention implements these optimizations by making the test for (and handling of) each case a separate code segment, and promotes this code to handle the task prior to the execution of any general query code.

Case #1:

The DNS server according to the present invention contains authoritative answer for a domain name query that is one label longer than the zone's domain name (e.g., with a zone name of “foo.com”, then an optimization is effective for “www.foo.com” but not for “www.mkt.foo.com”).

Case #2:

The DNS server according to the present invention has delegated the next-level subdomain name (e.g., the incoming query is for the domain name “www.mkt.foo.com”, which is in the zone “foo.com”, then the optimization is effective if the “mkt.foo.com” zone has been subdelegated).

The use of these specific optimizations does not preclude the development of additional optimizations. The fundamental realization and requirements remain unchanged, allowing common case optimizations to be applied to outcomes based on revised outcome probabilities.

Specifically, further common case optimizations specified rely on restrictions on the records in the database to guarantee the validity of the query response. For example, a generalization of Case #1 (above) that optimizes for arbitrary length domain name queries (e.g., the incoming query is for the domain name “www.unit.mkt.foo.com” within the zone for “foo.com”). This case can be optimized if no conflicting records are present, i.e., any record that could alter the precedence made for the optimization case (e.g., an intervening NS record or wildcard record associated with the domain name “mkt.foo.com” would have an impact on the above example of “www.unit.mkt.foo.com” in zone “foo.com”).

Additionally, the DNS query strategy according to the present invention allows for flexible/dynamic optimization code to be constructed, where, e.g., a specific ordering of individual common case optimizations is associated with each zone, based on prior knowledge or statistics maintained about each zone. This technique can be applied so that the best strategy is selected at the granularity of each zone, each server, or any identifiable class of query stream.

Data Caching and Cache Invalidation

Dynamic data caching is a mechanism that has been applied to achieve performance in many types of systems, but has never before been use to provide a fast-access data repository of authoritative data within an Domain Name Server.

The Domain Name System was designed with an integrated “time to live” (TTL) caching mechanism, and we note three example applications of caching elsewhere within the Internet and Domain Name System.

Applications such as web browsers frequently maintain copies of DNS records obtained while processing HTTP requests, and use applicable DNS records for subsequent requests. This use of caching does not maintain authoritative data, nor does it directly effect the operation of a DNS server.

Caching DNS servers (also known as recursive servers or “helper” servers) provide a separate function from “hosting” DNS servers. Recursive servers act on the behalf of an application (e.g., a user's web browser) and query a hierarchical series of hosting DNS servers to obtain the required DNS response. Information obtained in the course of a DNS query resolution may be maintained and used to expedite subsequent DNS queries, until each record's specified time-to-live has expired. This is a fundamental use within the DNS, but only addresses the behavior of non-authoritative servers when handling authoritative data.

Conventional primary DNS servers (e.g., as embodied by the “bind” serve distribution) read all authoritative domain information into a computer memory direclty from files, and answer queries based on a complete memory-resident copy of all domain information. Unlike the above caching examples, this is not an application of dynamic caching, but is a static copy of DNS information that does not change or replace based on well-known caching criteria such as frequency of use, nor does it embody any dynamic mechanisms for maintaining cache consistency. There is no dynamic mechanism for a “cache miss” that involves the standard alternative method of making a backup query to the primary (i.e., non-cache) repository.

According to embodiments of the present invention, the DNS server maintains an internal dynamic cache of recently-used authoritative DNS records taken from the database repository. Two embodiments are specified: (1) where individual resource records are cached separately and subsequent DNS response are comprised of the individual records, and (2) where the entire response to a DNS query is cached as an aggregate and are immediately available for a subsequent response, eliminating overhead required to construct a complete response. The strategy for handling incoming DNS queries includes an examination of the internal cache for efficient access to data, and if not available, a subsequent query to the primary data repository (database) is made. These mechanisms are used for both “positive caching,” i.e., when the data exists, and “negative caching,” i.e., when the server can authoritatively respond that the information does not exist.

The DNS server according to the present invention also embodies cache replacement mechanisms to control the amount of “stale” (infrequently used) data in the cache, and to allow for effective utilization of cache and system resources. Multiple embodiments exist to remove DNS data from the cache based on frequency or timeliness of use.

Cache Invalidation

A dynamic caching system must employ cache invalidation mechanisms to guarantee that information in the cache corresponds to the state of the primary data repository. This requires that data items are removed from (or replaced within) the cache when the corresponding information is changed within the primary data repository. This allows a DNS server according to the present invention to accurately reflect the correct information within the system.

The DNS server according to the present invention are embodied by a number of related cache invalidation mechanisms that address the complete range of transaction types that can be performed on the primary data repository, and the type of cache data that can be maintained in the system. The design space that defines the cache transactions of interest is represented by the Table below which specifies twenty four different cache invalidation transactions that can be addressed by the invention's cache invalidation strategy. Note that not every space need be addressed by a particular embodiment of the invention, and that some cache invalidation mechanisms will address multiple invalidation requirements.

| | | Query Cache | Query Cache | Query Cache |
|---|---|---|---|---|
| | Record Cache | (Answers) | (Authority) | (Additional) |
| Delete from | Positive | Positive | Positive | Positive |
| Primary | -vs.- | -vs.- | -vs.- | -vs.- |
| Dbase | Negative | Negative | Negative | Negative |
| Addition to | Positive | Positive | Positive | Positive |
| Primary | -vs.- | -vs.- | -vs.- | -vs.- |
| Dbase | Negative | Negative | Negative | Negative |
| Modify within | Positive | Positive | Positive | Positive |
| Primary | -vs.- | -vs.- | -vs.- | -vs.- |
| Dbase | Negative | Negative | Negative | Negative |

Multiple invalidation mechanisms can be applied together, so that each addresses a subset of the potential cache interactions and requirements. Further, these mechanisms can embody varying criteria for timeliness of data invalidation, according to the importance assigned to each subset. For example, when caching entire DNS responses the data within an Answer section may be considered more critical than the data within an Authority section. In this case, mechanisms can be employed that immediately respond to updates to information in the Answer section, while other less timely mechanisms will eventually invalidate the records within the Authority section.

System-Level Mechanisms

The system-level mechanisms according to the present invention work synergistically, enabling the DNS System according to the present invention to provide enhanced/integrated management of information, and to provide a range of performance enhancement for incoming queries and internal transactions.

Modular data-centric design

Database-layer synchronization

Single IP address announcement of replicated servers

Modular Data-Centric Design

The DNS domain name server according to the present invention (e.g., DNS₁ 100 of FIG. 1) separates the functionality of the standard monolithic Internet server into two distinct components: a commercial database system as the data repository, and a DNS wire-protocol server designed to answer queries based on authoritative DNS data from the database component. This architectural choice provides for a clean modular design, which in turn provides a flexible and scalable platform that is leveraged to provide a diverse set of features and inventions.

Data-Centric Modeling and Functional Server Module Extensions—The two-component design allows for modular extensions to both the data model, and the functions (e.g., servers) that operate on the system. Embodiments of this invention include, but are not limited to, one or more user interfaces for data management, transaction processors to provide an extensible API for data management, Internet system monitors that can query external system status (e.g., webserver availability) and affect changes to the data repository, and servers for other Internet directory servers (e.g., whois, radius, etc).

Integrated Access Control Mechanisms-Using a database repository for DNS information allows several principle objects (e.g., users and other network data schemas) to be modeled and managed. A significant feature of the DNS Domain Management System according to the present invention is the ability to control and delegate the many-to-many access patterns of users accessing domain name data.

Query and Context Specific Responses—Conventional (prior art) DNS servers take as input a <domain name, query type, query class> tuple, and return the appropriate resource records. The DNS system according to the present invention has revised the basic query/response transaction by incorporating additional fields within the data model such that the response to a query can be based on additional criteria. These criteria can be comprised of information obtained from the incoming query (e.g., source IP address), information available to the local server (e.g., time of day or server identity), and similar context or query specific information.

Dynamically Configurable DNS Record Types—The DNS server according to the present invention allows new resource record types to be defined, and immediately incorporated into the system. Based on resource record templates included in the data model, the DNS server according to the present invention system can incorporate new record types in minutes without additional low-level code development. This is in contrast to the conventional (prior art), where deployment of a new resource record type requires considerable low-level program design and coding, and requires a new server binary be deployed on all applicable machines. Moreover, combined with context specific responses (above), domain administrators may define their own “local” types that are specific to the answers returned for their DNS domain.

Ability to deploy and maintain a state-of-the-art data management service based on commodity implementations of core database technologies. The conventional (prior art) systems for Domain Name System management deploy integrated ad-hoc implementations of database technology, which lag advanced database features and make it difficult to deploy new features based on database technology advances.

Database-Layer Synchronization

The DNS system according to the present invention maintains data consistency between multiple redundant servers (e.g., DNS₁, DNS₂, . . . , DNSₙ in FIG. 1) by propagating changes to the managed data using database-level transaction processing. This has advantages over conventional (prior art) consistency mechanisms, which are based on application-level transactions. These advantages include:

Virtually immediate propagation of changes to Domain Name System information. This is particularly important when inaccurate information must be corrected, or when critical domain information changes frequently and changes must be visible quickly. For example, one of the most frequently changed zones, “.COM”, also has the greatest number of records. Using conventional (prior art) systems, “.COM” has historically been restricted to a twelve-hour periodic updates. Using the DNS system of the present invention, changes to “.COM” are routinely propagated within 5-15 minutes.

Ability to accept and propagate changes to Domain Name System information from multiple servers, and consequently, the ability to make data management more reliable with better system availability and performance. This is in contrast to conventional (prior art) DNS systems, which do not have the conflict resolution mechanisms required to support multiple sources of update transactions.

Single IP Address Deployment for Replicated Servers

Globally distributed server replicas (e.g., DNS₁, DNS₂, . . . , DNSₙ) provide the reliability, throughput and low delay required to scale a large commercial service. The servers are tied together using advanced Internet routing mechanisms that are reactive to the state of individual server replicas. In preferred embodiments, each DNS system according to the present invention shares a common IP address and supports a name server replica. The shared IP addresses are injected into the Internet routing mesh by each server so that Internet routers will direct IP packets to the nearest topological server. Each server replica is monitored for correct behavior, and the IP route is withdrawn if the server no longer responds to DNS queries. This mechanism provides the following benefits:

User DNS queries are directed to the nearest DNS replica minimizes the delay experienced for DNS resolution.

Transitory server and network failures are transparent to a user's DNS query and application transaction. Servers that are not reachable or functional are invisible, and DNS queries arrive at the nearest functional server without experiencing the delay for standard DNS timeout and retransmission.

The DNS system acquires user proximity information based on the server replica that receives the user DNS query. This information can be used to provide proximity based responses to direct users to nearby application servers.

Implementation

The Database

This section describes the unique database schema of the database 102.

Overview

The database 102 according to preferred embodiments of this invention is organized and structured according to the following unique database schema. The database schema involves fourteen (14) tables. Only three (3) of these tables contain actual data (i.e., DNS & Contact), the other eleven (11) tables are needed to manage the data. The schema allows management of who has access to which data, how can they access it, who can create new data, and how they should be billed for use of the system.

The data managed by the DNS Server 100 is (a) contact information, (b) zone information, and (c) resource record information. Although zones and resource records are related, the system must have the ability to manage them distinctly. The reason for this is to enable targeting different users, some of which want to use the Server 100 to manage an entire zone for them, and some of which will just enter individual resource records (in a particular zone).

For any data that can put in the system, there are two access control mechanisms involved: (1) a mechanism that specifies whether the item can be put in (created) in the system, and (2) a mechanism that specifies how items can be accessed.

TABLE LIST & SUMMARY

| Table Name | Description |
|---|---|
| LOGIN | User information (to establish identity on the system) |
| SYS_MGMT | Describes how the DNS system is managed (e.g., who can create |
| | new zones, billing policy, etc) |
| RRJUMBO | combined Resource Record (RR) index and data. |
| CONTACT | people/role/organization (like whois) |
| CONTACT_ASSOC | indicates association between contact information, and other |
| | data/items (e.g., zones or RRs) |
| ZONE | basic mgmt information for a related set of DNS RRs |
| ZONE_INTERFACE | list of “outside” servers the system must talk to primaries/masters |
| | OR secondaries we update) |
| ZONE_CNTL | much like information in SOA record |
| ZONE_MGMT | zone owner describes how zone may be used (e.g., who can create |
| | new RRs, billing policy, etc) |
| ZONE_SERVERS | maintains list of which zones in system, and which IP addresses can |
| | do zone transfer |
| RR_MGMT | indicates logins that can modify specific RRs (Resource Records) |
| BillingPolicy | rules/policy owners set for billing others for use |
| BillingInfo | actual billing information for a particular object (derived from |
| | owners BillingPolicy) |
| USAGE_HISTORY | contains past usage data (to answer billing concerns) |
| RRTEMPLATE | describes DNS RRs the system knows about (includes standard and |
| | user defined RRs) |
| IPV4RANGE | restricts (or allows) access per source IP address |

Table Schema

This section describes what information is in the tables and, in some cases, gives the formats and sizes of the data used in some embodiments of the present invention.

The LOGIN table describes identity within DNS system of the present invention. The table includes information on how to authenticate a user to system. The LOGIN Table is established via login/password, X.509, PGP, DNSSec, etc.

The following table summarizes the fields of the LOGIN table.

LOGIN

| Field | Description | Relationship to other Tables |
|---|---|---|
| Id | internal dbase index/pointer | appears in other tables |
| | | indicating this users has some |
| | | claim/access to the object |
| Email | contact information | |
| Ipaddr | restrict logins to specific IP range | index to IPV4RANGE table |
| x509id | ID for primary authentication method | |
| Username | backup login name | |
| Password | backup password | |
| Passques | user-supplied question for lost information | |
| Passansw | user-supplies answer for lost information | |

The SYS_MGMT table (described below) provides a template about use, access, etc. It provides information about how the system is managed; who can access, modify, create new “objects”, and information on how users are charged for access. The SYS_MGMT table allows the DNS according to the present invention to be deployed in different ways (e.g., closed access at large companies versus open ISP access). Some preferred embodiments allow deployment of two object types to be created, namely contacts and zones. Both can be created by anyone. Contacts can be created at no charge; zones may or may not incur charges (perhaps per-user).

SYS_MGMT

| Field | Description | Relationship to other Tables |
|---|---|---|
| Objtype | what type of objects can be created | ** |
| Access | type (create or read) | ** |
| Login | (loginid OR “ANY”) | ID in LOGIN table about who |
| | | can create |
| Ipaddr | restrict/grant access by IPsrc Addr | ** |
| Billing | specifies how to charge for access | index into BILLING table |

The RRJUMBO table represents DNS resource record (RR) information. This table is for the “index” or “lookup” of the incoming query, and contains columns for different parts of RR data section. Resource records are defined in RFC 1035 [Network Working Group Request for Comments: 1035, P. Mockapetris, ISI, November 1987] which is incorporated herein by reference.

RRJUMBO

| Field | Description | Relationship to other Tables |
|---|---|---|
| Id | internal dbase ID | referenced by other tables |
| Active | indicates RR is “active” | |
| | (e.g., paid for) | |
| Dead | indicates “machine” inactive | |
| Zone | zone membership identifier | indicates RR associated with |
| | | ZONE table |
| Dname | domain name | |
| | (e.g., “www.ultradns.com”) | |
| Lname | Lower case Dname to optimize | |
| | lookups | |
| Type | RR type | |
| Class | RR Class | |
| servers | indicates which server return | |
| | particular RR | |
| Time | Indicates time frame RR is | |
| | returned | |
| ipv4addr | index into IPV4RANGE Table | index into IPV4RANGE table (to |
| | | specify per IPaddress RRs) |
| ip_low | simple (hi-performance) IP | |
| | source address specification | |
| ip_high | simple (hi-performance) IP | |
| | source address specification | |
| ip_bits | simple (hi-performance) IP | |
| | source address specification | |
| create_who | login ID of record creator | indicates record created by |
| | | LOGIN table |
| create_ip | IP address of creator (if | |
| | anonymous) | |
| Create_date | when created | |
| update_who | login ID last modify | login id of last update |
| update_when | last modified time | |
| Billing | index to BillingInfo | billing information associated with |
| | | RR |
| Readcnt | recent RR reads | |
| Readsince | start time of read count | |
| writeent | recent RR changes | |
| Writesince | start time of write count | |
| Ttl | Resource record TTL (time to | |
| | live) (seconds) | |
| f1 | RRdata field #1 | |
| F2 | RRdata field #2 | |
| F3 | RRdata field #3 | |
| F4 | RRdata field #4 | |
| F5 | RRdata field #5 | |
| F6 | RRdata field #6 | |
| F7 | RRdata field #7 | |
| F8 | RRdata field #8 | |
| ref1 | dname reference for | |
| | “additional” RRs | |

A “DNS lookup” in the RRJUMBO table uses (matches against) the following six values to find the requested DNS resource record:

domain name (from dns query packet)

dns type (from dns query packet)

dns class (from dns query packet)

server id (name/id of server answering query)

time (current time of day at server)

source IP address (from the IP packet)

Note that the use of the RRdata fields, f1 . . . f8, depends on the type of RR (e.g., MX records will use f1 and f2, A records will only use f1, and SOA records will use f1-f7).

The RRJUMBO table is used to store data for multiple purposes: in addition to storing “live” domain records, “template” records are stored which embody the mechanism to provide configurable DNS records. Each DNS Resource Record type is represented by one or more template records in the RRJUMBO table which specify the format and structure of each record type.

The CONTACT Table contains information about a person, role, or organization (i.e., this is basically “whois” information). Note that the information in the CONTACT Table has nothing to do system login.

CONTACT

| Field | Description | Relationship to other Tables |
|---|---|---|
| Id | Internal dbase index | referenced by other tables |
| Order | Sequence information for | |
| | related records | |
| Type | name, phone, fax, email, etc. | |
| | (see list below) | |
| Information | Associated information (e.g., | |
| | name: Steve Hotz) | |
| Anonacl | read permission for field (e.g., | |
| | do not give out phone number) | |
| ipaddr | IP address based read | index into IPV4RANGE Table |
| | restrictions/permissions | |

The TYPE values for above “type” field (similar to RIPE-181) include:

name

email

email-alt

phone

phone-alt

fax-no

nic-hdl

nic-hdl-alt

address (multiple-line text string)

source (in case information came from another place)

date-create

date-update

The CONTACT_ASSOC Table indicates association between contact information, and other data/items (e.g., zones or RRs)

CONTACT_ASSOC

| Field | Description | Relationship to other Tables |
|---|---|---|
| Id | name/id of object (e.g., “ultradns.com”.) | internal identifier of DNS data |
| | | item (e.g., contact, zone, or RR) |
| Objtype | {system, zone, record} | |
| contact | id of CONTACT information | |
| Type | {admin, tech, billing, registration} | |
| Public | {yes, no} read access for general public | |

The ZONE table basic information about a group of related RRs.

ZONE

| Field | Description | Relationship to other Tables |
|---|---|---|
| Zone | Name of the zone (e.g., “ultradns.com”) | Every column in this table |
| Owner | LOGIN id of zone owner | relates to other tables. |
| Billing | How this zone is billed (BillingInfo) | |
| zonecntl | ZONE_CTRL id for internal consistency | |

The ZONE_INTERFACE Table specifies external servers (i.e., servers that are not embodiments of the present invention) that must either be used as primary/master, or updated as secondary/slave.

ZONE_INTERFACE

| Field | Description | Relationship to other Tables |
|---|---|---|
| Zone | zone being updated/transferred | refers to zone name in numerous |
| | | tables |
| inout | {in, out} | |
| srvname | name of server | |
| Srvip | IP address of server | |
| ctrl | ZONE_CTRL id for record controlling | reference into ZONE_CTRL |
| | frequency | table |
| view_ip | if multi-dimension records, snapshot this IP | |
| view_time | if multi-dimension, snapshot at this time | |
| view_srv | if multi-dimension, snapshot for server | |

The ZONE_CNTL Table contains zone control information, similar to SOA parameters. This Table is used for database consistency (may not be needed with internal Oracle, however, can specify interface with external servers).

ZONE_CNTL

| Field | Description | Relationship to other Tables |
|---|---|---|
| Id | Internal Identifier | Referenced by other tables |
| Serial | | |
| Refresh | | |
| Retry | | |
| Expire | | |
| Mincache | | |
| Flags | Notify turned on | |

The ZONE_MGMT table includes information about how a particular zone is managed; who can access, modify, create new “objects”, and information on how the user is charged for access.

ZONE_MGMT

| Field | Description | Relationship to other Tables |
|---|---|---|
| Zone | zone being managed | relates several tables holding |
| | | zone information |
| login | login ID with access (or “ANY”) | LOGIN table for who has access |
| ipaddr | source IP access restrictions | IPv4Range table for src address |
| | | access |
| Billing | billing policy associated with access | index into BillingPolicy table |
| rrlist | bit map of RR types that can be created | |
| Mods | allow zone modifications: | |
| | can modify via dynamic update | |
| | modify all RRs | |
| | modify all contact information | |
| | modify zone information | |
| | modify zone_mgmt information | |
| Features | Bit map of allowed features | |
| | define new types | |
| | create multi-dimensional | |
| | can create RRs that allow dynamic | |
| | updates | |
| | can create new RRs using dynamic | |
| | update | |
| | dead machine monitoring other | |
| Flags | indicate other actions associated with | |
| | update/access indicating required | |
| | per-record information (i.e., contact) | |
| | owner requires change notification | |
| | (via email) | |

The ZONE_SERVERS table is an auxiliary table listing zones for which the system is responsible. This table is used by servers to find zones for which they are authoritative.

ZONE_SERVERS

| Field | Description | Relationship to other Tables |
|---|---|---|
| Zone | Zone name | Zone name relates to multiple |
| | | tables |
| Server | Server holding zone | |
| xferip | IPV4RANGE allowed zone transfers | IPv4Range index |

The RR_MGMT Table provides an access list for specific RRs.

RR_MGMT

| Field | Description | Relationship to other Tables |
|---|---|---|
| Rrod | Rrindex id | Every column (except flags) |
| Login | Login allowed to change (or “ANY”) | relates to columns in other |
| Ipaddr | src IP based access restrictions | tables. |
| Flags | access allowed (initially, all or nothing) | |

The BillingPolicy table (set by owner(s) of system or zone) contains information about how to bill for system use. The owner of system sets this up ahead of time, and the system enforces the various billing policies.

BillingPolicy

| Field | Description | Relationship to other Tables |
|---|---|---|
| billp_id | internal dbase index | referenced by other table |
| | | columns |
| What | zone, contact, dname, RRtype(s), feature | |
| type | one-time, read, write, time, | |
| | <feature_name> | |
| Unit | <count> for read/write | |
| | day\|week\|month\|year for time or feature | |
| Amt | Amount (in dollars) | |
| cnd_type | reads OR writes [must be greater than] | |
| cnd_unit | count [per] | |
| cnd_time | time unit (day\|week\|month\|year) | |
| intro_time | days before billing starts | |
| period | yearly/monthly/choice | |
| year_discount | can offer (percentage) discount for | |
| | yearly rate | |

Each zone may specify more than one policy. For example,:

| | | | | <cond> | | | |
|---|---|---|---|---|---|---|---|
| <what> | <type> | <unit> | <amt> | Type | > | Unit | Time |
| Zone | 1-time | | 29.99 | | | | |
| Zone | Time | Year | 9.99 | | | | |
| Zone | Write | 1 | 1.00 | Write | > | 10 | Month |
| Feature | Dyn_Upd | Month | 1.99 | | | | |

The BILLINGINFO Table contains information about who and when to bill for use.

Billinginfo

| Field | Description | Relationship to other Tables |
|---|---|---|
| billi_id | internal dbase index | referenced by other table columns |
| who_id | billing contact index | reference to CONTACT table |
| Method | Credit card, usmail, email | |
| billp_id | Reference to BillingPolicy table | |
| Credcard | credit card account | |
| expire | credit card expire date | |
| card_id | billing address for credit card (if different | reference to CONTACT table |
| | from who_id) | |
| billp_id | index to Billing Policy record | |
| create_date | when billing record was created | |
| next_date | next statement date | |

The USAGE_HIST Table contains historical system/information usage information. Can attach to various objects: RRdata, Zone, Contact, etc. (Some preferred embodiments attach to RRs)

USAGE_LIST

| Field | Description | Relationship to other Tables |
|---|---|---|
| Id | internal dbase ID of object tracked | relates to Id field of other tables |
| Objtype | RR/zone/contact/other | determines which “other table” |
| access | read/write/other | |
| start | start of period (seconds since epoch) | |
| End | duration of period (e.g., in seconds) | |
| cnt | number of accesses | |

Preferably use logging is (a) only turned on for some records, and (b) could be a “premium service”. Must keep “current” usage for billing, but this feature is “turned on”.

The IPv4Range Table contains CIDRized subnet masks, primarily used for address based (i.e., weak) authentication. This table is used for (a) handing out RRs based on srcipaddress, and (b) simple access control for updates to data (e.g., using dynamic updates as implemented).

IPv4Range

| Field | Description | Relationship to other Tables |
|---|---|---|
| Ipid | index of IP range spec | this table id serves as index, and appears in |
| | | other tables (indicating whether access is |
| | | allowed from specific source IP addresses |
| Flag | flag indicating | |
| | allowed/prohibited | |
| bits | number of bits in mask | |
| Low | lowest address value | |
| High | highest address value | |

### EXAMPLE

| Listid | flag | bits | iprangelow | iprangehi |
|---|---|---|---|---|
| #1 | prohibit | 0 | 0x00000000 | 0xffffffff |
| #1 | allow | 16 | 0x80090000 | 0x8009ffff |
| #2 | allow | 0 | 0x00000000 | 0xffffffff |
| #2 | prohibit | 16 | 0xa0070000 | 0xa007ffff |
| #2 | prohibit | 16 | 0xa0090000 | 0xa009ffff |
| #3 | prohibit | 0 | 0x00000000 | 0xffffffff |
| #3 | allow | 16 | 0xc9140000 | 0xc914ffff |
| #3 | prohibit | 24 | 0xc9142800 | 0xc91428ff |
| #3 | prohibit | 24 | 0xc9142a00 | 0xc9142aff |

#1 allows small number of addresses;
#2 prohibits small number of addresses;
#3 allows all in range, with exceptions;

The following section provides the database field formats and sizes for a preferred embodiment of the present invention. Some of the fields have common sizes:

256 char==dnames

10 num==32 bit integers (e.g., IPv4addr and time in seconds)

14 num==internal identifier

LOGIN

| | | |
|---|---|---|
| Id | num 14 | null-ok |
| Email | vch 256 | |
| Ipaddr | num 14 | |
| x509id | vch 256 | |
| Username | vch 64 | |
| Password | vch 32 | |
| Passques | vch 80 | |
| Passansw | vch 80 | |

SYS_MGMT

| | | |
|---|---|---|
| Objtype | Vch 16 | |
| Access | Vch 16 | |
| Login | Num 14 | |
| Ipaddr | Num 14 | null-ok |
| billing | Num 14 | null-ok |

RRJUMBO

| | | |
|---|---|---|
| id | num 14 | |
| active | num 1 | |
| dead | num 2 | |
| zone | vch 256 | |
| dname | vch 256 | |
| type | vch 16 | |
| class | vch 16 | |
| servers | vch 32 | null-ok |
| time | vch 168 | null-ok |
| ipv4addr | num 14 | null-ok |
| ip_low | num 10 | null-ok |
| ip_high | num 10 | null-ok |
| ip_bits | num 3 | null-ok |
| create_who | num 14 | |
| create_ip | num 10 | |
| create_date | num 10 | |
| update_who | num 14 | |
| update_when | num 10 | |
| billing | num 14 | null-ok |
| readcnt | num 8 | null-ok |
| readsince | num 10 | null-ok |
| writecnt | num 8 | null-ok |
| writesince | num 10 | null-ok |
| TTL | num 10 | |
| f1 | vch 1024 | |
| f2 | vch 1024 | null-ok |
| f3 | vch 256 | null-ok |
| f4 | vch 256 | null-ok |
| f5 | vch 256 | null-ok |
| f6 | vch 256 | null-ok |
| f7 | vch 256 | null-ok |
| f8 | vch 256 | null-ok |
| ref1 | vch 256 | null-ok |

CONTACT

| | | |
|---|---|---|
| id | num 14 | |
| order | num 2 | |
| type | vch 16 | |
| info | vch 168 | |
| anonacl | vch 8 | null-ok |
| ipaddr | num 14 | null-ok |

CONTACT_ASSOC

| | | |
|---|---|---|
| id | num 14 | |
| objtype | vch 16 | |
| contact | num 14 | |
| type | vch 20 | null-ok |
| public | vch 8 | |

ZONE

| | | |
|---|---|---|
| zone | vch 256 | |
| owner | num 14 | |
| billing | num 14 | null-ok |
| zonecntl | num 14 | |

ZONE_INTERFACE

| | | |
|---|---|---|
| zone | vch 256 | |
| inout | vch 8 | |
| srvname | vch 256 | null-ok |
| Srvip | num 10 | null-ok |
| Ctrl | num 14 | |
| view_ip | num 10 | null-ok |
| view_time | num 3 | null-ok |
| view_srv | num 3 | null-ok |

ZONE_CNTL

| | | |
|---|---|---|
| Id | num 14 | |
| Serial | num 10 | |
| Refresh | num 10 | |
| Retry | num 10 | |
| Expire | num 10 | |
| Mincache | num 10 | |
| Flags | vch 8 | null-ok |

ZONE_MGMT

| | | |
|---|---|---|
| Zone | vch 256 | |
| Login | num 14 | null-ok |
| Ipaddr | num 14 | null-ok |
| Billing | num 14 | null-ok |
| Rrlist | vch 256 | |
| Mods | vch 16 | |
| features | vch 16 | null-ok |
| Flags | vch 8 | |

ZONE_SERVERS

| | | |
|---|---|---|
| Zone | vch 256 | |
| Server | vch 256 | |
| Xferip | num 14 | null-ok |

RR_MGMT

| | | |
|---|---|---|
| rrid | num 14 | |
| login | num 14 | null-ok |
| ipaddr | num 14 | null-ok |
| flags | vch 8 | null-ok |

BILLINGPOLICY

| | | |
|---|---|---|
| billp_id | num 14 | |
| what | vch 32 | |
| type | vch 32 | |
| unit | vch 16 | |
| amt | num 8 | |
| cnd_type | vch 8 | null-ok |
| cnd_unit | num 8 | null-ok |
| cnd_time | vch 8 | null-ok |
| intro_time | num 6 | |
| period | vch 8 | |
| year_discount | num 4 | |

BILLINGINFO

| | | |
|---|---|---|
| billi_id | num 14 | |
| who_id | num 14 | |
| method | vch 12 | |
| credcard | num 16 | null-ok |
| expire | vch 7 | null-ok |
| card_id | num 14 | null-ok |
| billp_id | num 14 | |
| create_date | num 10 | |
| next_date | num 10 | |

USAGE_HIST

| | |
|---|---|
| id | num 14 |
| objtype | vch 16 |
| access | vch 16 |
| start | num 10 |
| end | num 10 |
| cnt | num 12 |

IPV4RANGE

| | |
|---|---|
| ipid | num 14 |
| flag | num 2 |
| bits | num 2 |
| low | num 10 |
| high | num 10 |

Design Choices

Probably the least obvious design choice is the way that CONTACT is laid out. What would be more obvious/natural is to have one table row represent each particular contact record. However, this design breaks contact information into multiple fields, and represents each field as a row in the database. This method is more flexible (given the flexible nature of the data), and supports the association and efficient lookup of “ACCESS POLICY” to individual fields (e.g., to allow random people looking at a CONTACT record to see an email address but not see a phone number associated with that record).

The SQL Interface

The SQL Interface 104 takes queries/requests for domain name/address resolution and returns the appropriate address and other information. The SQL implementing the interface 104 in a preferred embodiment is listed below (in the Table titled SQL Query).

### EXAMPLE

Here is a sample query made by a user 108 of the DNS 100 according to the present invention. The request is processed by the query mechanism 106 which uses the SQL interface 104 to access the database 102.

Query: a.b.c.d.wonk.com. <type> where the system knows that it has “wonk.com.ZONE”

Then, in the worst case, the system has to make the following queries into the database 102:

| | | |
|---|---|---|
| a.b.c.d.wonk.com. | <type> | ## commonly returns ANSWER |
| b.c.d.wonk.com. | NS | ## commonly returns AUTH data |
| a.b.c.d.wonk.com. | NS | ## common to indicate sub-delegation |
| *.b.c.d.wonk.com. | <type> | |
| b.c.d.wonk.com. | NS | |
| *.c.d.wonk.com. | <type> | |
| c.d.wonk.com. | NS | |
| *.d.wonk.com. | <type> | |
| d.wonk.com. | NS | |
| *.wonk.com. | <type> | |

This invention embodies a query strategy that significantly reduces the average number of database queries required to complete a DNS query.

There are essentially two common cases:

(1) no sub-delegation—Query gets simple answer for foo.wonk.com

(2) the system will end-up telling about sub-delegation—Query made for a.b.c.d.wonk.com gets NS for d.wonk.com

In both of the common cases noted above, the answer “dname” is likely to be one component longer than the zone name. So, the system tests this before making the query (i.e., the system does not want to query for “a.b.c.d wonk.com”, “b.c.d.wonk.com”, and “c.d.wonk.com” just to finally say that the delegation is made at “d.wonk.com”).

Consequently, the following query optimization (in the query mechanism 106) can be used:

If the requested name is one component longer than zone name, then look for a quick answer.

This can be written as:

if (shorten(req.dname) == ZONE) {

| | |
|---|---|
| SQL(<req.dname>, <type> | ## |

SQL(d.wonk.com, <type>,

| | |
|---|---|
| shorten(<req.dname>), NS) | ## |

wonk.com, NS)
if (<type> found)

return answer;
save_NS_for_later( );

SQL(req.dname, NS,

“*” + shorten(req.dname), <type>);
if (“*” found, return answer and my NS records);
if (NS found, return authority);
return(NXDOMAIN);

}

If long request name, check for shortest delegation first. For example, if the request name is “a.b.c.d.wonk.com”, check if “d.wonk.com” has NS.

SQL(shorten.to_one_piece(<req.dname>), NS); if (NS found) return;

If neither optimization worked then start with original question.

SQL(<req.name>, <type>,

zone.name, NS);

if (answer found) {

return(answer + NS);

} else {

save_NS_for_later( );

}

If no answer is found then loop through and look for NS delegations.

for (working_name = req.dname,

next_name = shorten(working_name);
next != zone;
working_name = next_name, next_name =

shorten(working_name)
) {

SQL(working_name, NS);
if (NS found) return;

}

No delegation made.

Now loop looking for “*” records.

for (working name = shorten(req.dname),

next_name = shorten(working_name)
next != zone;
working_name = next_name, next_name =

shorten(working_name)
) {

SQL(“*” + working_name, <type>;
if (<type> found) {
return (answer + save_NS_records)

}
}

return (NXDOMAIN);

### EXAMPLE

Give the example query “foo.bar.wonk.com. MX”, call following SQL (Table XX) with following variables:

req.name1=“foo.bar.wonk.com.”

req.name2=“*.bar.wonk.com.”

req.name3=“bar.wonk.com.”

req.type=15 (this is the MX type)

req.class=1 (this is the IN class)

req.time=<current_time>

req.server=<server ID#>

req.ipaddr=<incoming pkt IP source>

SQL QUERY

SELECT * FROM RRJUMBO, RR

The main “start with” clause gets the ANSWERS and AUTHORATATIVE, plus it gets any
“*” records that exist.

START WITH
(

(RR.dname = ‘req.name1’ AND ((RR.type = ‘req.type’)
OR (RR.type = = 2)))

OR

(RR.dname = ‘req.name2’ AND (RR.type = ‘req.type’))

OR

(RR.dname = ‘req.name3’ AND (RR.type = 2))

)

| | |
|---|---|
| AND | |
| RR.class = ‘req.class’ | AND |
| substr(RR.time, ‘req.time’, 1) = 1 | AND |
| substr(RR.servers, ‘req.server’, 1) = 1 | AND |
| RR.active = 1 | AND |
| RR.dead = 0 | AND |

This is part of main query, that handles the IPv4range

EXISTS (select * FROM ipv4range, IP WHERE

| | |
|---|---|
| RR.ipv4addr = IP.ipid | AND |
| IP.low <= req.ipaddr | AND |
| IP.high >= req.ipaddr | AND |
| IP.flag = 2 | AND) |

This part of query grabs ADDITIONAL records

CONNECT BY

| | |
|---|---|
| PRIOR ref1 = dname | AND |

| | |
|---|---|
| type = 1 | AND |
| class = ‘req.class’ | AND |
| substr(time, ‘req.time’, 1) = 1 | AND |
| substr(servers, ‘req.server’, 1) = 1 | AND |
| active = 1 | AND |
| dead = 0 | AND |

Make certain ADDITIONAL RECORDS also have IPv4 permission

EXISTS (select * FROM ipv4range, IP WHERE

| | |
|---|---|
| RR.ipv4addr = IP.ipid | AND |
| IP.low <= req.ipaddr | AND |
| IP.high >= req.ipaddr | AND |
| IP.flag = 2 | AND) |

SELECT * FROM rrjumbo, RR
START WITH
(

(RR.dname = ‘req.name1’ AND ((RR.type = ‘req.type’)
OR (RR.type = = 2)))

OR

(RR.dname = ‘req.name2’ AND (RR.type = ‘req.type’))

OR

(RR.dname = ‘req.name3’ AND (RR.type = 2))

)

| | |
|---|---|
| AND | |
| RR.class = ‘req.class’ | AND |
| substr(RR.time, ‘req.time’, 1) = 1 | AND |
| substr(RR.servers, ‘req.server’, 1) = 1 | AND |
| RR.active = 1 | AND |
| RR.dead = 0 | AND |

EXISTS (select * FROM ipv4range, IP WHERE

| | |
|---|---|
| RR.ipv4addr = IP.ipid | AND |
| IP.low <= req.ipaddr | AND |
| IP.high >= req.ipaddr | AND |
| IP.flag = 2 | AND) |

CONNECT BY

| | |
|---|---|
| PRIOR ref1 = dname | AND |

| | |
|---|---|
| type = 1 | AND |
| class = ‘req.class’ | AND |
| substr(time, ‘req.time’, 1) = 1 | AND |
| substr(servers, ‘req.server’, 1) = 1 | AND |
| active = 1 | AND |
| dead = 0 | AND |

EXISTS (select * FROM ipv4range, IP WHERE

| | |
|---|---|
| RR.ipv4addr = IP.ipid | AND |
| IP.low <= req.ipaddr | AND |
| IP.high >= req.ipaddr | AND |
| IP.flag = 2 | AND) |

Other Features

Building a modular system has allowed additional mechanisms to be incorporated easily into the system which can serve as the base for new features/uses.

Configurable Resource Record Types

The DNS according to some embodiments of the present invention has over thirty (30) defined resource record types, which provide data formats/fields for use by different applications; current implementations hard-code the type definitions. Thus, the present invention offers users the ability to dynamically configure RR types, to allow directory-enabled applications to be deployed and tested within short time frames.

Context Sensitive (Query-Specific) Answers

In the abstract, a directory service maps a query's incoming request (key) to an outgoing response (data indexed by the key). Using a relational database model gives the present invention an effective mechanism to add other components to the lookup key. In the DNS example, a different answer can be given depending on various context information: from the packet (IP address), from the machine (local time), and from global system (which server location). Thus, for example, the system may provide different answers at different times of day or to different geographic regions.

Dynamic Data Cache

In some embodiments, the DNS server 100 incorporates a dynamic load-on-demand cache algorithm which significantly enhances performance by reducing the amount of data that must be retrieved from the database 102.

When an inbound query is received, the server 100 will first attempt to find the answer in the data cache 110. If the answer exists and is fresh, the response will be sent directly from the cached data stored in data cache 110. If the answer exists in the cache 110 but is stale, or if the answer does not yet exist in the cache, the data will be acquired from the database 102, transmitted in the response, and then added to or updated within the cache 110. In some embodiments, the cache is maintained in a Most Recently Used order to optimize lookup times and facilitate cache management.

Items in the cache 110 have a maximum lifetime which ranges from the time to live (TTL) of the lowest resource record (RR) in the complete answer to the maximum cache time value configured for the server as a whole. For records that change frequently, the TTL value can be set to zero to ensure the data is never added to cache and always retrieved from the database.

By setting a relatively short lifetime on data in the cache 110, the server 100 can provide maximum throughput while still offering near real-time propagation of zone changes. Because the cache is load-on-demand, the DNS daemon can be up and ready to respond to queries within moments of execution.

In addition to normal caching of DNS response data, the cache algorithm is designed so that negative caching is also achieved. For example, if a request is made for a host that does not exist in an active domain, the negative response will be saved just like a valid response. If the server is for some reason hit with a barrage of requests for this same invalid host, they can be filled using the negative response in cache, once again eliminating unnecessary calls to the database.

Further, in some embodiments, a management thread is incorporated into the cache design. This thread comes to life at a configurable interval and walks through the RR data cache, deleting any stale entries that it encounters. This feature ensures that the most active data is always the most readily available.

In some embodiments, a cache invalidation mechanism is incorporated that is responsible for removing (or modifying) data within the dynamic cache so that the cache accurately and acceptably reflects changes made to the primary data repository.

Implementation Details

An embodiment of this invention has been implemented. The DNS server 100 was designed on top of and tightly integrated with the database 102. The database 102 was implemented using Oracle, however, care was taken to modularize the database interface so that the system could easily be integrated with a database from a different vendor, such as Sybase or Informix. The server was developed using Gnu C++ on a Linux platform. The server build process was later expanded to support both Linux and Solaris.

Implementations of the present invention can be written in any suitable high-level computer language. Further, while aspects of the present invention have been implemented in software running on a computer system as described above, all aspects of the present invention can also be implemented in hardware or in a combination of software and hardware. That is, although described with reference to a particular system, the present invention operates on any computer system and can be implemented in software, hardware or any combination thereof. When implemented fully or partially in software, the invention can reside, permanently or temporarily, on any memory or storage medium, including but not limited to a RAM, a ROM, a disk, an ASIC, a PROM and the like.

Relevant portions of the source code are included in the appendix to this application, which source code appendix is considered to be part of the application. The source code is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

While the above embodiments relate to domain name processing, one skilled in the art will realize that domain names are merely one example of directory services, and that the present invention is applicable to other directory services.

Thus are provided methods, systems and devices for scalable domain name resolution. One skilled in the art will appreciate that the present invention can be

We claim:

1. A low delay domain name resolution system, comprising:
one or more servers, each of the servers configured to resolve domain name resolution requests and including a routing mechanism reactive to a state of the server;
each of the servers including a query mechanism, the query mechanism configured to obtain a group of records from a database using one or more compound database queries, such that the server obtains the group of records at a data rate faster than the underlying data retrieval rate of the database.

2. The system of claim 1 in which the query mechanism is further configured to organize a sequence of multiple queries based on the records obtained using earlier queries.

3. The system of claim 1 in which the query mechanism is further configured to organize the sequence of multiple queries by forming, for each domain name resolution request, at least one common case query based on the content of the domain name query, and to execute the at least one common case query prior to any other general query.

4. The system of claim 3 in which the records are maintained according to a plurality of domain name zones, and the query mechanism is further configured to optimize a sequence of the common case queries based on statistics maintained for each zone.

5. The system of claim 1, wherein a single one of the compound queries obtains from the database all records required to construct a domain name resolution response.

6. The system of claim 5, in which the compound query retrieves combinations of answer, authority and additional records from the database.

7. The system of claim 6, in which the compound query retrieves available CNAME records from the database.

8. The system of claim 3, in which the common case queries are based on the outcome probabilities for the domain name resolution request.

9. The system of claim 1, wherein the records obtained from the database include an Internet Protocol address corresponding to the domain name resolution request.

10. The system of claim 1, in which the routing mechanism routes domain name resolution requests to the nearest server based on user proximity information.

11. The system of claim 1, in which the routing mechanism monitors each server and withdraws routes to servers that do not respond to domain name resolution requests.

12. A low delay domain name resolution method, comprising:
receiving a domain name resolution request at one or more servers;
forming, using a query mechanism, at least one compound database query corresponding to the domain name resolution request;
sending the at least one compound database query to a database;
obtaining from the database a domain name resolution response including a group of database records, wherein the records are received by the one or more servers at a data rate faster than the underlying data retrieval rate of the database.

13. The method of claim 12, further comprising organizing a sequence of multiple queries based on the records obtained using earlier queries.

14. The method of claim 13 in which the organizing further comprises:
forming, for each domain name resolution request, at least one common case query based on the content of the domain name query; and
performing the at least one common case query prior to any other general query.

15. The method of claim 14, in which the records are maintained according to a plurality of domain name zones, and in which the forming at least one common case query is based on statistics maintained for each zone.

16. The method of claim 12, wherein a single one of the compound queries obtains from the database all records required to construct a domain name resolution response.

17. The method of claim 12, in which the group of records comprises combinations of answer, authority and additional records from the database.

18. The method of claim 17, in which the group of records further comprises available CNAME records from the database.

19. The method of claim 14, in which the common case queries are based on the outcome probabilities for the domain name resolution request.

20. The method of claim 12, wherein the records obtained from the database include an Internet Protocol address corresponding to the domain name resolution request.

21. The method of claim 12, further comprising routing the domain name resolution request to the nearest server based on user proximity information.

22. The method of claim 12, further comprising:
monitoring each server; and
withdrawing routes to servers that do not respond to domain name resolution requests.

23. A method of providing an answer to a request for an Internet Protocol (IP) address of one of a plurality of devices on the Internet, the method comprising:
obtaining a user request for an IP address corresponding to a domain name;
determining, if there is a plurality of choices of authoritative name servers from where an answer can be obtained, an authoritative name server based on common case optimization, the answer containing at least one IP address corresponding to the domain name and other relevant information;
constructing an aggregated query with respect to the authoritative name server to retrieve the answer; and
providing the answer by querying the authoritative name server using the aggregated query.

24. The method according to claim 23, wherein the other relevant information includes at least some of:
names of at least one authoritative name server; and
IP addresses of the at least one authoritative server.

25. The method according to claim 23, wherein determining the authoritative name server based on common case optimization comprises:
selecting, if the domain name is one label longer than that of the name of the zone for which a first name server that receives the request is responsible, the first name server representing the zone as the authoritative name server;
selecting, if no answer is obtained from the first name server representing the zone, a second name server that has been delegated for the next level domain name relative to the zone as the authoritative name server;
selecting, if no answer is obtained from the second name server, the authoritative name server by at least one of:
recursively selecting the authoritative name server with respect to the domain name until the answer is found; or
selecting the authoritative name server based on statistics dynamically collected with respect to zones represented by different authoritative name servers.

26. The method according to claim 23, wherein said constructing comprises:
extracting the domain name from the request;
deriving at least one domain name corresponding to at least one authoritative name server;
identifying context information; and
building the aggregated query based on the domain name, the at least one authoritative name serve domain name, and the context information.

27. The method according to claim 26, wherein the context information includes at least one of:
context information from the user request;
local context information; and
global context information.

28. The method according to claim 27, wherein the context information includes address information indicating an address of the user.

29. The method according to claim 27, wherein the context information includes the local time.

30. The method according to claim 27, wherein the context information includes a geographic location.

31. The method according to claim 23, wherein providing the answer comprises:
querying the authoritative name server using the aggregated query;
receiving query result from the authoritative name server; and
deriving the answer from the query result.

32. The method according to claim 31, wherein said querying includes retrieving the query result from a cache.

33. The method according to claim 32, wherein said retrieving query result from the cache comprises:
identifying the query result in the cache; and
validating the query result.

34. The method according to claim 33, wherein said validating comprises:
if the query result is fresh, sending the query result directly from the cache; and
if the query result either is stale or does not exist in the cache, then
retrieving the query result from a database;
sending the query result; and
updating the cache to reflect the retrieved query result.

35. The method according to claim 34, wherein items in the cache includes individual records or aggregated records.

36. The method according to claim 35, wherein each record in the cache corresponds to either:
a positive record representing a positive query result wherein a request is made for a host that exists in an active domain; or
a negative record representing a negative query result wherein a request is made for a host that does not exist in an active domain.

37. The method according to claim 36, wherein each record in the cache has a maximum lifetime, ranging from the time to live for the lowest resource record in a complete answer to a maximum cache time value, used to evaluate whether the each record is stale.

38. The method according to claim 34, further comprising:
retrieving the query result from a database of the authoritative name server if the query result is not found in the cache.

39. A system for processing domain name requests, the system comprising:
a query mechanism constructed and adapted to:
obtain a user request for an IP address corresponding to a domain name;
determine, if there is a plurality of choices of authoritative name servers from where an answer can be obtained, an authoritative name server based on common case optimization, the answer containing at least one IP address corresponding to the domain name and other relevant information;
construct an aggregated query with respect to the authoritative name server to retrieve the answer; and
provide the answer by querying the authoritative name server using the aggregated query.

40. The system according to claim 39, wherein the other relevant information includes at least some of:
names of at least one authoritative name server; and
IP addresses of the at least one authoritative server.

41. The system according to claim 39, wherein determine the authoritative name server based on common case optimization comprises:
selecting, if the domain name is one label longer than that of the name of the zone for which a first name server that receives the request is responsible, the first name server representing the zone as the authoritative name server;
selecting, if no answer is obtained from the first name server representing the zone, a second name server that has been delegated for the next level domain name relative to the zone as the authoritative name server;
selecting, if no answer is obtained from the second name server, the authoritative name server by at least one of:
recursively selecting the authoritative name server with respect to the domain name until the answer is found; or
selecting the authoritative name server based on statistics dynamically collected with respect to zones represented by different authoritative name servers.

42. The system according to claim 39, wherein said construct the aggregated query comprises:
extracting the domain name from the request;
deriving at least one domain name corresponding to at least one authoritative name server;
identifying context information; and
building the aggregated query based on the domain name, the at least one authoritative name serve domain name, and the context information.

43. The system according to claim 42, wherein the context information includes at least one of:
context information from the user request;
local context information; and
global context information.

44. The system according to claim 42, wherein the context information includes address information indicating an address of the user.

45. The system according to claim 44, wherein the context information includes the local time.

46. The system according to claim 42, wherein the context information includes a geographic location.

47. The system according to claim 39, wherein provide the answer comprises:
querying the authoritative name server using the aggregated query;
receiving query result from the authoritative name server; and
deriving the answer from the query result.

48. The system according to claim 47, further comprising a cache wherein the query mechanism is constructed and adapted to perform the query by attempting first to retrieve the query result from the cache.

49. The system according to claim 48, wherein said retrieving query result from the cache comprises:
identifying the query result in the cache; and
validating the query result.

50. The system according to claim 49, wherein said validating comprises:
if the query result is fresh, sending the query result directly from the cache; and
if the query result either is stale or does not exist in the cache, then retrieving the query result from a database;
sending the query result; and
updating the cache to reflect the retrieved query result.

51. The system according to claim 50, wherein items in the cache includes individual records or aggregated records.

52. The system according to claim 51, wherein each record in the cache corresponds to either:
a positive record representing a positive query result wherein a request is made for a host that exists in an active domain; or
a negative record representing a negative query result wherein a request is made for a host that does not exist in an active domain.

53. The system according to claim 52, wherein each record in the cache has a maximum lifetime, ranging from the time to live for the lowest resource record in a complete answer to a maximum cache time value, used to evaluate whether the each record is stale.

54. The system according to claim 53, wherein the query mechanism is further constructed and adapted to retrieve, when the query result is not found in the cache, the query result from a database of the authoritative name server.
